(19) United States
(12) Patent Application Publication
(10) Pub. No.: US 2012/0045630 A1
(43) Pub. Date: Feb. 23, 2012

(54) MULTILAYER STRUCTURE AND METHOD OF MAKING THE SAME

(75) Inventors: Yan Bo Zhang, Shanghai (CN); Ming He Li, Shanghai (CN); Dong Wang, Shanghai (CN); Jun Tao Xia, Shanghai (CN); David J. Magley, Midland, MI (US)

(73) Assignee: Dow Global Technologies LLC, Midland, MI (US)

(21) Appl. No.: 13/266,642

(22) PCT Filed: May 5, 2009
(86) PCT No.: PCT/CN09/71641

§ 371 Date: Oct. 27, 2011

(51) Int. Cl. B32B 21/08; B32B 7/12; B29C 65/02; B32B 7/02

(52) U.S. Cl. 428/214; 428/511; 428/339; 428/215; 428/337; 156/285

(57) ABSTRACT

The instant invention is a multi layer structure, and method of making the same. The multilayer structure according to the present invention comprises (a) one or more skin layers comprising a polymeric material; (b) one or more adhesive layers derived from one or more polyolefin dispersions; and (c) one or more base layers comprising a wood based material; wherein the adhesive layer is disposed therebetween the base layer and the skin layer.

### FIELD OF INVENTION

The instant invention relates to a multilayer structure, and method of making the same.

### BACKGROUND OF THE INVENTION

The use of wood based material such as medium-density fiberboard (MDF) to make furniture, such as home furniture, office furniture, kitchen cabinets, countertops, computer desks, and the like is generally known. MDF is an engineered wood product formed by breaking down softwood into wood fibers, often in a defibrator, combining it with wax and a resin binder, and forming panels by applying high temperature and pressure. The use of a polyvinylchloride (PVC) as a skin layer associated with one or more surfaces of wood based material, e.g. MDF, is also generally known. The use of PVC as a skin layer provides such furniture with water resistant properties, impact resistant properties, or abrasion resistant properties and aesthetic effects. The PVC layer is typically laminated as a skin layer. However, vacuum molding is typically employed when the wood based material, e.g. MDF, is irregularly shaped. Typically, solvent borne or aqueous dispersion adhesive systems based on polyurethane (PU) are used as adhesives. However, while such adhesive systems may be able to facilitate relatively high adhesion between PVC and wood based materials such as MDF, they generally cannot achieve such high adhesion properties without excessive volatile emissions or higher cost. Additionally, such PU based adhesive systems may further require the use of one or more solvents. Alternatively, waterborne vinyl acetate emulsions (VAE) may be used as the adhesive layer to bond PVC to the wood composite. However, VAE based emulsions generally have poor adhesion to the PVC skin layer(s), and are only used in low end applications where adhesion performance is not critical.

Accordingly, there is need for aqueous adhesive systems providing higher levels of adhesion therebetween the PVC layer and the wood based material such as MDF, with lower organic volatile emissions and at a reduced cost. Furthermore, there is still a need for a method of producing aqueous adhesive systems providing higher levels of adhesion therebetween the PVC layer and the wood based material such as MDF.

### SUMMARY OF THE INVENTION

The instant invention is a multi layer structure, and method of making the same.

In one embodiment, the instant invention provides a multilayer structure comprising (a) one or more skin layers comprising a polymeric material; (b) one or more adhesive layers derived from one or more polyolefin dispersions; and (c) one or more base layers comprising a wood based material; wherein at least one adhesive layer is disposed therebetween the base layer and the skin layer.

In an alternative embodiment, the instant invention further provides a method for making a multilayer structure comprising the steps of (1) providing one or more skin layers comprising a polymeric material; (2) providing one or more one or more base layers; (3) providing one or more polyolefin dispersions comprising (a) at least one or more base polymers; (b) at least one or more stabilizing agents; (c) a liquid media; and (d) optionally one or more neutralizing agents; (4) applying the one or more polyolefin dispersions to one or more surfaces of the one or more base layers; (5) removing at least a portion of the liquid media from the one or more polyolefin dispersions; (6) thereby forming one or more adhesive layers, wherein at least one adhesive layer is associated with at least one surface of said base layer; (7) thereby forming a first intermediate structure; (8) heat laminating the one or more skin layers to the intermediate structure; thereby forming the multilayer structure, wherein the adhesive layer is disposed therebetween the skin layer and the base layer.

In an alternative embodiment, the instant invention provides a multilayer structure and method of making the same, in accordance with any of the preceding embodiments, except that polyolefin dispersion further comprises a wetting agent, an anti-foam agent, or a leveling agent.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is an exemplary embodiment of a multilayer structure according to the present invention;

FIG. 2 is an exemplary laminated multilayer structure tested for its 180° C. peel test; and

FIG. 3 is a comparative laminated multilayer structure tested for its 180° C. peel test.

### DETAILED DESCRIPTION OF THE INVENTION

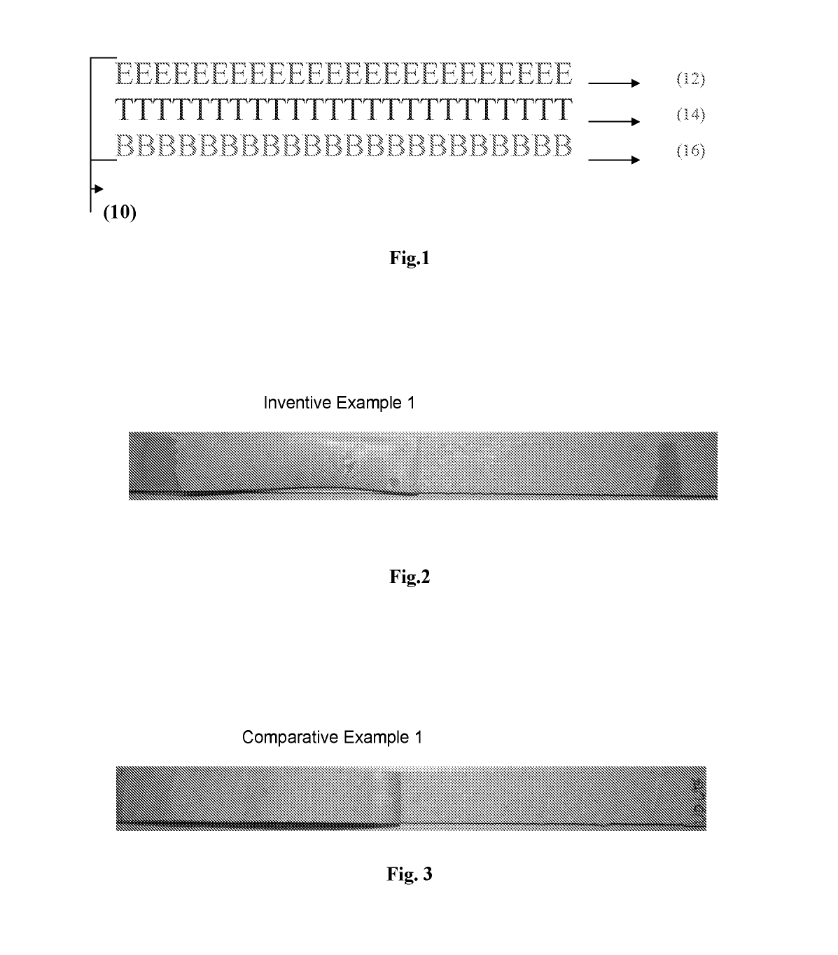

Referring to the drawings wherein like numerals indicate like elements, there is shown, in FIG. 1, an exemplary embodiment of a multilayer structure 10 according to the present invention. Multilayer structure 10 comprises (a) one or more skin layers 12 comprising a polymeric material; (b) one or more adhesive layers 14 derived from one or more polyolefin dispersions; and (c) one or more base layers 16 comprising a wood based material; wherein the adhesive layer 14 is disposed therebetween the base layer 16 and the skin layer 12.

The method for making a multilayer structure according this invention comprises the following steps: (1) providing one or more skin layers comprising a polymeric material; (2) providing one or more one or more base layers; (3) providing one or more polyolefin dispersions comprising (a) at least one or more base polymers; (b) at least one or more stabilizing agents; (c) a liquid media; and (d) optionally one or more neutralizing agents; (4) applying the one or more polyolefin dispersions to one or more surfaces of the one or more base layers; (5) removing at least a portion of the liquid media from the one or more polyolefin dispersions; (6) thereby forming one or more adhesive layers, wherein at least one adhesive layer is associated with at least one surface of said base layer; (7) thereby forming a first intermediate structure; (8) heat laminating the one or more skin layers to the intermediate structure; thereby forming the multilayer structure, wherein the adhesive layer is disposed therebetween the skin layer and the base layer.

One or more skin layers comprise one or more polymeric materials. Such polymeric materials include, but are not limited to, thermoplastic polymeric materials, or thermoset polymeric materials.

Thermoplastic polymeric materials suitable for skin layer include, but are not limited to, vinyl chloride polymers. The vinyl chloride polymer component is a solid, high molecular weight polymer that may be a polyvinyl chloride homopolymer or a copolymer of vinyl chloride having copolymerized units of one or more additional comonomers. When present, such comonomers may account for up to 20 weight percent of the copolymer, for example from 1 to 5 weight percent of the copolymer. Examples of suitable comonomers include, but are not limited to, C₂ to C₆ olefins, for example ethylene and propylene; vinyl esters of straight chain or branched C₂ to C₄ carboxylic acids, such as vinyl acetate, vinyl propionate, and vinyl 2-ethyl hexanoate; vinyl halides, for example vinyl fluoride, vinylidene fluoride or vinylidene chloride; vinyl ethers, such as vinyl methyl ether and butyl vinyl ether; vinyl pyridine; unsaturated acids, for example maleic acid, fumaric acid, methacrylic acid and their mono- or diesters with C₁ to C₁₀ mono- or dialcohols; maleic anhydride, maleic acid imide as well as the N-substitution products of maleic acid imide with aromatic, cycloaliphatic and optionally branched aliphatic substituents; acrylonitrile and styrene. Such homopolymers and copolymers may be prepared by any conventional polymerization method.

The vinyl chloride polymer may be a grafted copolymer of vinyl chloride. For example, ethylene copolymers, such as ethylene vinyl acetate, and ethylene copolymer elastomers, such as EPDM (copolymers comprising copolymerized units of ethylene, propylene and dienes) and EPR (copolymers comprising copolymerized units of ethylene and propylene) that are grafted with vinyl chloride may be used as the vinyl chloride polymer. The vinyl chloride polymer may also be plasticized with a phthalate, e.g. diisononyl phthalate, to improve the flexibility of the polymer sheet. The PVC sheet may also be impact modified with the addition of a minor amount of chlorinated polyethylene. Such chlorinated polyethylenes are, for example, commercially available from The Dow Chemical Company under the tradename TYRIN™.

Thermoset polymeric materials suitable for skin layer include, but are not limited to, polymeric materials such as LAMINEX™ or FORMICA™ sheet. LAMINEX™ or FORMICA™ sheets are composites of melamine formaldehyde, melamine urea formaldehyde, and/or phenol formaldehyde pressure laminated with various layers of printed and plain paper to form a decorative but hard, durable, composite surface. The laminates generally have a thickness in the range of from 0.5 mm to 20 mm.

In one embodiment, the one or more skin layers may comprise melamine; or in alternative embodiment, the one or more skin layers may comprise Formica or other composite based on urea formaldehyde, phenol formaldehyde and/or melamine formaldehyde. The one or more skin layers may also be a wood veneer used to decorate a fiberboard or particle board substrate.

The one or more skin layers may comprise a film, e.g. a single layer, a multiple layer film such as co-extruded film or a laminated film, a foil, a sheet, a leaf, or combinations thereof. Such one or more skin layers may further be surface treated. The one or more skin layers may have a uniform surface; or in the alternative, the one or more skin layers may have a non-uniform. The one or more skin layers may have a monotonous surface, e.g. smooth or unvarying surface, or in the alternative, the one or more skin layers may have a rough surface; or in the alternative, a textured surface. Each skin layer may have a thickness in the range of less than or equal to 5000 μm; for example each skin layer may have a thickness from a lower limit of 10 μm, 100 μm, 200 μm, 500 μm, or 1000 μm to an upper limit of 100 μm, 200 μm, 500 μm, 1000 μm, or 5000 μm.

The one or more base layers comprise a wood based material. Wood based materials include, but are not limited to, medium density fiber board, particle board, wood boards, and composite wood products. The one or more base layers may each have a thickness in the range of less than 50 cm, for example, less than 40 cm, or less than 30 cm, or less than 20 cm, or less than 10 cm, or less than 5 cm, or in the range of 0.5 mm to 20 mm. Such wood based materials are generally known.

The one or more adhesive layers are derived from one or more polyolefin dispersions. Each one or more adhesive layers may have a thickness in the range of less than or equal to 500 μm; for example each adhesive layer may have a thickness from a lower limit of 10 μm, 100 μm, or 200 μm, to an upper limit of 100 μm, 200 μm, or 500 μm. Each adhesive layer may comprise from 1 g/m² to 2000 g/m² by dry weight of one or more polyolefin dispersions. For example, each adhesive layer may comprise from a lower limit of 1, 5, 10, 20, 50, 100, or 200 g/m² to an upper limit of 10, 20, 50, 100, 200, 250, 500, 1000, or 2000 g/m² by dry weight of one or more dispersions. Each adhesive layer may be formed via spray coating process, curtain coating process, blade printing process, metered size press process, rod coating process, flexographic printing process, rotogravure printing process, air knife coating process, immersion (dip) coating process, gap coating process, or rotary screen coating process.

The polyolefin dispersion may comprise at least one or more base polymers, one or more stabilizing agents, a liquid media such as water or alkaline water, and optionally one or more neutralizing agents, optionally one or more wetting agents, optionally one or more antifoam agents, one or more leveling agents.

### Base Polymer

The base polymer may, for example, be a polymer selected from the group consisting of ethylene-based polymers, and propylene-based polymers.

In selected embodiments, the base polymer is formed from ethylene-alpha olefin copolymers or propylene-alpha olefin copolymers. In one embodiment, the base polymer comprises one or more non-polar polyolefins.

In one particular embodiment, the base polymer is a propylene/alpha-olefin copolymer, which is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra.

The propylene/alpha-olefin copolymer may have a melt flow rate in the range of from 0.1 to 25 g/10 minutes, measured in accordance with ASTM D-1238 (at 230° C./2.16 Kg). All individual values and subranges from 0.1 to 25 g/10 minutes are included herein and disclosed herein; for example, the melt flow rate can be from a lower limit of 0.1 g/10 minutes, 0.2 g/10 minutes, or 0.5 g/10 minutes to an upper limit of 25 g/10 minutes, 15 g/10 minutes, 10 g/10 minutes, 8 g/10 minutes, or 5 g/10 minutes. For example, the propylene/alpha-olefin copolymer may have a melt flow rate in the range of 0.1 to 10 g/10 minutes; or in the alternative, the propylene/alpha-olefin copolymer may have a melt flow rate in the range of 0.2 to 10 g/10 minutes.

The propylene/alpha-olefin copolymer has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method, as described above. The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

The propylene/alpha-olefin copolymer comprises from 1 to 40 percent by weight of the units derived from one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of units derived from one or more alpha-olefin comonomers; or in the alternative, the propylene/alpha-olefin copolymer comprises from 1 to 30 percent by weight of units derived from one or more alpha-olefin comonomers; or in the alternative, the propylene/alpha-olefin copolymer comprises from 3 to 27 percent by weight of units derived from one or more alpha-olefin comonomers; or in the alternative, the propylene/alpha-olefin copolymer comprises from 3 to 20 percent by weight of units derived from one or more alpha-olefin comonomers; or in the alternative, the propylene/alpha-olefin copolymer comprises from 3 to 15 percent by weight of units derived from one or more alpha-olefin comonomers.

The propylene/alpha-olefin copolymer has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

In one embodiment, the propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C₄₋₁₀α-olefin; and containing an average of at least 0.001, preferably an average of at least 0.005 and more preferably an average of at least 0.01, long chain branches/1000 total carbons, wherein the term long chain branch refers to a chain length of at least one (1) carbon more than a short chain branch, and wherein short chain branch refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. The maximum number of long chain branches in the propylene interpolymer is not critical to the definition of this embodiment of the instant invention, but typically it does not exceed 3 long chain branches/1000 total carbons. Such propylene/alpha-olefin copolymers are further described in details in the U.S. Provisional Patent Application No. 60/988,999 and International Patent Application No. PCT/US08/082,599, each of which is incorporated herein by reference.

In other selected embodiments, olefin block copolymers, e.g., ethylene multi-block copolymer, such as those described in the International Publication No. WO2005/090427 and U.S. patent application Ser. No. 11/376,835 may be used as the base polymer. Such olefin block copolymer may be an ethylene/α-olefin interpolymer:

(a) having a M_{w}/Mₙ from about 1.7 to about 3.5, at least one melting point, Tₘ, in degrees Celsius, and a density, d, in grams/cubic centimeter, wherein the numerical values of Tₘ and d corresponding to the relationship:

Tₘ>−2002.9+4538.5(d)−2422.2(d)²; or

(b) having a M_{w}/Mₙ from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≧48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or

(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481−1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

The ethylene/α-olefin interpolymer may also:

(a) have a molecular fraction which elutes between 40° C. and 130° C. when fractionated using TREF, characterized in that the fraction having a block index of at least 0.5 and up to about 1 and a molecular weight distribution, M_{w}/Mₙ greater than about 1.3; or

(b) have an average block index greater than zero and up to about 1.0 and a molecular weight distribution, M_{w}/Mₙ greater than about 1.3.

In alternative embodiments, polyolefins such as polypropylene, polyethylene, and copolymers thereof, and blends thereof, as well as ethylene-propylene-diene terpolymers, may be used as the base polymer. In some embodiments, exemplary olefinic polymers include, but are not limited to, homogeneous polymers described in U.S. Pat. No. 3,645,992 issued to Elston; high density polyethylene (HDPE) as described in U.S. Pat. No. 4,076,698 issued to Anderson; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by a process disclosed in U.S. Pat. Nos. 5,272,236 and 5,278,272, the disclosures of which are incorporated herein by reference; and high pressure, free radical polymerized ethylene polymers and copolymers such as low density polyethylene (LDPE).

Polymer compositions described in U.S. Pat. Nos. 6,566,446, 6,538,070, 6,448,341, 6,316,549, 6,111,023, 5,869,575, 5,844,045, or 5,677,383, each of which is incorporated herein by reference in its entirety, may be also be used as the base polymer. Of course, blends of polymers can be used as well. In some embodiments, the blends of base polymers include two different Ziegler-Natta polymers. In other embodiments, the blends of base polymers can include blends of a Ziegler-Natta and a metallocene polymer. In still other embodiments, the base polymer blend may be a blend of two different metallocene polymers. In other embodiments polymers produced from single site catalysts may be used. In yet another embodiment, block or multi-block copolymers may be used. Such polymers include those described and claimed in WO2005/090427 (having priority to U.S. Ser. No. 60/553,906, filed Mar. 7, 2004).

In some particular embodiments, the base polymer is a propylene-based copolymer or interpolymer. In some embodiments, the propylene/ethylene copolymer or interpolymer is characterized as having substantially isotactic propylene sequences. The term “substantially isotactic propylene sequences” and similar terms mean that the sequences have an isotactic triad (mm) measured by ¹³C NMR of greater than about 0.85, preferably greater than about 0.90, more preferably greater than about 0.92 and most preferably greater than about 0.93. Isotactic triads are well-known in the art and are described in, for example, U.S. Pat. No. 5,504,172 and WO 00/01745, which refer to the isotactic sequence in terms of a triad unit in the copolymer molecular chain, determined by ¹³C NMR spectra.

In other particular embodiments, the base polymer may be ethylene vinyl acetate (EVA) based polymers. In other embodiments, the base polymer may be ethylene-methyl acrylate (EMA) based polymers. In other particular embodiments, the ethylene-alpha olefin copolymer may be ethylene-butene, ethylene-hexene, or ethylene-octene copolymers or interpolymers. In other particular embodiments, the propylene-alpha olefin copolymer may be a propylene-ethylene or a propylene-ethylene-butene copolymer or interpolymer.

In certain embodiments, the base polymer can be an ethylene-octene copolymer or interpolymer having a density between 0.863 and 0.911 g/cc and melt index (190° C. with 2.16 kg weight) from 0.1 to 1200 g/10 min, or in the alternative, from 0.1 to 1000 g/10 min, and in another alternative, 0.1 to 100 g/10 min. In other embodiments, the ethylene-octene copolymers may have a density between 0.863 and 0.902 g/cm³ and melt index (measured at 190° C. under a load of 2.16 kg) from 0.8 to 35 g/10 min.

In certain embodiments, the base polymer can be a propylene-ethylene copolymer or interpolymer having an ethylene content between 5 and 20 percent by weight and a melt flow rate (measured at 230° C. under a load of 2.16 kg) from 0.5 to 300 g/10 min. In other embodiments, the propylene-ethylene copolymer or interpolymer may have an ethylene content between 9 and 12 percent by weight and a melt flow rate (measured at 230° C. under a load of 2.16 kg) from 1 to 100 g/10 min.

In certain other embodiments, the base polymer can be a low density polyethylene having a density between 0.911 and 0.925 g/cm³ and melt index (measured at 190° C. under a load of 2.16 kg) from 0.1 to 100 g/10 min.

In other embodiments, the base polymer can have a crystallinity of less than 50 percent. For example, the crystallinity of the base polymer may be from 5 to 35 percent; or in the alternative, the crystallinity can range from 7 to 20 percent.

In certain other embodiments, the base polymer can have a melting point of less than 110° C. For example, the melting point may be from 25 to 100° C.; or in the alternative, the melting point may be between 40 and 85° C.

In certain embodiments, the base polymer can have a weight average molecular weight greater than 20,000 g/mole. For example, the weight average molecular weight may be from 20,000 to 150,000 g/mole; or in the alternative, from 50,000 to 100,000 g/mole.

The aqueous dispersion may comprise from 1 to 96 percent by weight one or more base polymers; for example, from 10 to 70, or from 20 to 70, or from 10 to 60, or from 20 to 60, or from 10 to 50, or from 20 to 50 percent by weight of one or more base polymers.

### Stabilizing Agents

The dispersion may further comprise at least one or more stabilizing agents, also referred to herein as dispersion agents, to promote the formation of a stable dispersion or emulsion. In selected embodiments, the stabilizing agent may be a surfactant, a polymer (different from the base polymer detailed above), or mixtures thereof. In certain embodiments, the stabilizing agent can be a polar polymer, having a polar group as either a comonomer or grafted monomer. In exemplary embodiments, the stabilizing agent comprises one or more polar polyolefins, having a polar group as either a comonomer or grafted monomer. Exemplary polymeric stabilizing agents include, but are not limited to, ethylene-acrylic acid (EAA) and ethylene-methacrylic acid copolymers, such as those available under the trademarks PRIMACOR™, commercially available from The Dow Chemical Company, NUCREL™, commercially available from E.I. DuPont de Nemours, and ESCOR™, commercially available from ExxonMobil Chemical Company and described in U.S. Pat. Nos. 4,599,392, 4,988,781, and 5,938,437, each of which is incorporated herein by reference in its entirety. Other exemplary polymeric stabilizing agents include, but are not limited to, ethylene ethyl acrylate (EEA) copolymer, ethylene methyl methacrylate (EMMA), and ethylene butyl acrylate (EBA). Other ethylene-carboxylic acid copolymer may also be used. Those having ordinary skill in the art will recognize that a number of other useful polymers may also be used.

Other stabilizing agents that may be used include, but are not limited to, long chain fatty acids or fatty acid salts having from 12 to 60 carbon atoms. In other embodiments, the long chain fatty acid or fatty acid salt may have from 12 to 40 carbon atoms.

Additional stabilizing agents that may be useful in the practice of the present invention include, but are not limited to, cationic surfactants, anionic surfactants, or a non-ionic surfactants. Examples of anionic surfactants include, but are not limited to, sulfonates, carboxylates, and phosphates. Examples of cationic surfactants include, but are not limited to, quaternary amines. Examples of non-ionic surfactants include, but are not limited to, block copolymers containing ethylene oxide and silicone surfactants. Stabilizing agents useful in the practice of the present invention can be either external surfactants or internal surfactants. External surfactants are surfactants that do not become chemically reacted into the base polymer during dispersion preparation. Examples of external surfactants useful herein include, but are not limited to, salts of dodecyl benzene sulfonic acid and lauryl sulfonic acid salt. Internal surfactants are surfactants that do become chemically reacted into the base polymer during dispersion preparation. An example of an internal surfactant useful herein includes 2,2-dimethylol propionic acid and its salts.

In certain embodiments, the dispersing agent or stabilizing agent may be used in an amount ranging from greater than zero to about 60 percent by weight based on the amount of base polymer (or base polymer mixture) used. For example, long chain fatty acids or salts thereof may be used from 0.5 to 10 percent by weight based on the amount of base polymer. In other embodiments, ethylene-acrylic acid or ethylene-methacrylic acid copolymers may be used in an amount from 0.01 to 60 percent by weight based on the weight of the base polymer; or in the alternative, ethylene-acrylic acid or ethylene-methacrylic acid copolymers may be used in an amount from 0.5 to 60 percent by weight based on the weight of the base polymer. In yet other embodiments, sulfonic acid salts may be used in an amount from 0.01 to 60 percent by weight based on the weight of the base polymer; or in the alternative, sulfonic acid salts may be used in an amount from 0.5 to 10% by weight based on the weight of the base polymer.

Examples of anionic surfactants are metal or ammonia salts of sulfonates, phosphates and carboxylates. Suitable surfactants include alkali metal salts of fatty acids such as sodium stearate, sodium palmitate, potassium oleate, alkali metal salts of fatty acid sulfates such as sodium lauryl sulfate, the alkali metal salts of alkylbenzenesulfones and alkylnaphthalenesulfones such as sodium dodecylbenzenesulfonate, sodium alkylnaphthalene-sulfonate; the alkali metal salts of dialkyl-sulfosuccinates; the alkali metal salts of sulfated alkylphenol ethoxylates such as sodium octylphenoxypolyethoxyeth-yl sulfate; the alkali metal salts of polyethoxyalcohol sulfates and the alkali metal salts of polyethoxyalkylphenol sulfates, metal sulfosuccinate such as dioctyl sodium sulfosuccinate, sodium lauryl sulfate, a sulfosuccinic acid-4-ester with polyethylene glycol dodecylether disodium salt, an alkyl disulfonated diphenyloxide disodium salt such as mono- and dialkyl disulfonated diphenyloxide, disodium salt, dihexyl sodium sulfosuccinate, polyoxy-1,2-ethandiyl-.alpha.-tridecyl-.omega.-hydroxyphosphate, and alkylethersulfate sodium salt

Examples of nonionic surfactants include polyethylene glycol fatty acid mono- and diesters (such as PEG-8 laurate, PEG-10 oleate, PEG-8 dioleate, and PEG-12 distearate); polyethylene glycol glycerol fatty acid esters (such as PEG-40 glyceryl laurate and PEG-20 glyceryl stearate); alcohol-oil transesterification products (such as PEG-35 castor oil, PEG-25 trioleate, and PEG-60 corn glycerides); polyglycerized fatty acids (such as polyglyceryl-2-oleate and polyglyceryl-10 trioleate); propylene glycol fatty acid esters (such as propylene glycol monolaurate); mono- and diglycerides (such as glyceryl monooleate and glyceryl laurate); sterol and sterol derivatives (such as cholesterol); sorbitan fatty acid esters and polyethylene glycol sorbitan fatty acid esters (such as sorbitan monolaurate and PEG-20 sorbitan monolaurate); polyethylene glycol alkyl ethers (such as PEG-3 oleyl ether and PEG-20 stearyl ether); sugar esters (such as sucrose monopalmitate and sucrose monolaurate); polyethylene glycol alkyl phenols (such as PEG-10-100 nonyl phenol, and PEG-15-100 octyl phenol ether); polyoxyethylene-polyoxypropylene block copolymers (such as poloxamer 108 and poloxamer 182); lower alcohol fatty acid esters (such as ethyl oleatea and isopropyl myristate); ethylene oxide adducts of phenols, such as nonyl phenol and any combinations thereof.

Additional examples of suitable ionic surfactants include fatty acid salts (such as sodium laurate and sodium lauryl scarcosinate); bile salts (such as sodium cholate and sodium taurocholate); phosphoric acid esters (such as diethanolammonium polyoxyethylene-10 oleyl ether phosphate); carboxylates (such as ether carbokylates and citric acid esters of mono and diglycerides); acyl lactylates (such as lactylic esters of fatty acids, and propylene glycol aginate); sulfates and sulfonates (such as ethoxylated alkyl sulfates, alkyl benzene sulfones, and acyl taurates); alkyl, aryl, and alkyl-aryl sulfonates and phosphates; and any combinations thereof.

If the polar group of the polymer is acidic or basic in nature, the polymeric stabilizing agent may be partially or fully neutralized with a neutralizing agent to form the corresponding salt. In certain embodiments, neutralization of the stabilizing agent, such as a long chain fatty acid or EAA, may be from 25 to 200 percent on a molar basis; or in the alternative, it may be from 50 to 110 percent on a molar basis. For example, for EAA, the neutralizing agent may be a base, such as ammonium hydroxide or potassium hydroxide, for example. Other neutralizing agents can include lithium hydroxide or sodium hydroxide, for example. In another alternative, the neutralizing agent may, for example, be any amine such as monoethanolamine, or 2-amino-2-methyl-1-propanol (AMP). Those having ordinary skill in the art will appreciate that the selection of an appropriate neutralizing agent depends on the specific composition formulated, and that such a choice is within the knowledge of those of ordinary skill in the art.

The aqueous dispersion may comprise from 1 to 70 percent by weight one or more stabilizing agents; for example, from 10 to 70, or from 20 to 70, or from 10 to 60, or from 20 to 60, or from 10 to 50, or from 20 to 50 percent by weight of one or more stabilizing agents.

### Fluid Medium

The dispersion further comprises a fluid medium. The fluid medium may be any medium; for example, the fluid medium may be water. Water content of the dispersion may preferably be controlled so that the solids content (base polymer plus stabilizing agent) is between about 1 percent to about 74 percent by volume. In particular embodiments, the solids range may be between about 10 percent to about 70 percent by volume. In other particular embodiments, the solids range is between about 20 percent to about 60 percent by volume. In certain other embodiments, the solids range is between about 30 percent to about 55 percent by volume.

### Fillers for the Dispersion

The dispersion may further comprise one or more fillers. The dispersion comprises from about 0.01 to about 600 parts by weight of one or more fillers per hundred parts by the combined weight of the base polymer, e.g., polyolefin, and the stabilizing agent. In certain embodiments, the filler loading in the dispersion can be from about 0.01 to about 200 parts by the weight of one or more fillers per hundred parts of the combined weight of the base polymer, e.g., polyolefin, and the stabilizing agent. The filler material can include conventional fillers such as milled glass, calcium carbonate, aluminum trihydrate, talc, antimony trioxide, fly ash, clays (such as bentonite or kaolin clays for example), or other known fillers.

### Additives for the Dispersion

The dispersion may further include additives. Such additives may be used with the base polymer, stabilizing agent, or filler used in the dispersion without deviating from the scope of the present invention. For example, additives may include, but are not limited to, wetting agents, surfactants, anti-static agents, antifoam agents, anti block agents, wax-dispersion pigments, neutralizing agents, thickeners, compatibilizers, brighteners, rheology modifiers, biocides, fungicides, additional surfactants, frothing agents, dispersants, fire retardants, pigments, antistatic agents, reinforcing fibers, antifoam agents, anti block agents antioxidants, preservatives, acid scavengers, wetting agents, leveling agents and the like.

The aqueous dispersion may comprise less than or equal to 2 percent by weight of one or more wetting agents; for example, 0.01 to 2 weight percent, or 0.1 to 1 weight percent, or 0.15 to 0.3 weight percent. Such wetting agents are commercially available for BYK Corporation under the tradename BYK-349.

Thickeners suitable for use in the practice of the present invention can be any known in the art such as for instance poly-acrylate, HEUR (Hydrophobe-modified Ethoxylated Urethane), ASE (alkaline-soluble emulsion) or cellulosics type such as cellulose ethers. For example, suitable thickeners include DSX-3291, commercially available from Cognis Corporation, ALCOGUM™ VEP-II from Alco Chemical Corporation, RHEOVIS™ and VISCALEX™ from Ciba Ceigy, UCAR® Thickener 146, or ETHOCEL™ or METHOCEL™ from The Dow Chemical Company and PARAGUM™ 241 from Para-Chem Southern, Inc., or BERMACOL™ from Akzo Nobel or AQUALON™ from Hercules or ACUSOL® from The Dow Chemical Company. Thickeners can be used in any amount necessary to prepare a dispersion of desired viscosity. The dispersion may comprise less than or equal to 2 percent by weight of one or more thickeners; for example, 0.01 to 2 weight percent, or 0.1 to 1 weight percent, or 0.15 to 0.3 weight percent.

### Dispersion Formulations

Exemplary dispersion formulations may include a base polymer, which may comprise at least one non-polar polyolefin, a stabilizing agent, which may comprise at least one polar polyolefin, water, and optionally one or more fillers and or additives. These solid materials, i.e. base polymer and stabilizing agents, are preferably dispersed in a liquid medium, which in certain embodiments is water.

In certain embodiments, sufficient neutralization agent is added to maintain a pH in the range of about 4 to about 12. In certain other embodiments, sufficient base is added to maintain a pH in the range about 6 to about 11; in certain other embodiments, the pH may be in the range of about 8 to about 10.5.

The aqueous dispersions may be characterized in having an average particle size diameter in the range of from 0.01 to 5.0 microns, or in the alternative from 0.1 to 5.0 microns. In other embodiments, the aqueous dispersion may have an average particle size diameter in the range of from 0.5 μm to 2.7 μm. In other embodiments, the aqueous dispersion may have an average particle size diameter in the range of from 0.8 μm to 1.2 μm. Average particle size diameter can, for example, be measured via a Beckman-Coulter LS230 laser-diffraction particle size analyzer or other suitable device.

The ultimate viscosity of the dispersion is controllable. Addition of the thickener to the dispersion including the amount of filler can be done with conventional means to result in viscosities as needed. Viscosities of thus dispersions can reach +3000 cP (Brookfield spindle 4 with 20 rpm) with moderate thickener dosing (up to 4% preferably, below 3% based on 100 phr of aqueous polymer dispersion). The starting polymer dispersion as described has an initial viscosity prior to formulation with fillers and additives between 20 and 1000 cP (Brookfield viscosity measured at room temperature with spindle RV3 at 50 rpm). Still more preferably, the starting viscosity of the dispersion may be between about 100 to about 600 cP. Preferably, viscosity measured at 20° C. should remain +/−10% of the original viscosity over a period of 24 hours, when stored at ambient temperature.

Exemplary aqueous dispersions are disclosed, for instance, in U.S. Patent Application Publication No. 2005/0100754, U.S. Patent Application Publication No. 2005/0192365, PCT Publication No. WO 2005/021638, and PCT Publication No. WO 2005/021622, which are all incorporated herein by reference.

### Forming the Dispersion

The aqueous dispersion can be formed by any number of methods recognized by those having skill in the art. In certain embodiments, the aqueous dispersion may be formed by using techniques disclosed for example, in the dispersions that were formed in accordance with the procedures as described in WO2005021638, which is incorporated by reference in its entirety.

In a specific embodiment, a base polymer, a stabilizing agent, and optionally a filler are melt-kneaded in an extruder along with water and a neutralizing agent, such as ammonia, potassium hydroxide, or a combination of the two to form a dispersion compound. Those having ordinary skill in the art will recognize that a number of other neutralizing agents may be used. In some embodiments, the filler may be added after blending the base polymer and stabilizing agent. In some embodiments, the dispersion is first diluted to contain about 1 to about 3% by weight water and then, subsequently, further diluted to comprise greater than about 25% by weight water.

Any melt-kneading means known in the art may be used. In some embodiments, a kneader, a BANBURY® mixer, single-screw extruder, or a multi-screw extruder is used. A process for producing the dispersions in accordance with the present invention is not particularly limited. One exemplary process is a process comprising melt-kneading the above-mentioned components according to U.S. Pat. No. 5,756,659 and U.S. Pat. No. 6,455,636.

For example, an extruder, in certain embodiments, e.g. a twin screw extruder, is coupled to a back pressure regulator, melt pump, or gear pump. Exemplary embodiments also provide a base reservoir and an initial water reservoir, each of which includes a pump. Desired amounts of base and initial water are provided from the base reservoir and the initial water reservoir, respectively. Any suitable pump may be used, but in some embodiments a pump that provides a flow of about 150 cc/min at a pressure of 240 bar is used to provide the base and the initial water to the extruder. In other embodiments, a liquid injection pump provides a flow of 300 cc/min at 200 bar or 600 cc/min at 133 bar. In some embodiments, the base and initial water are preheated in a preheater.

Resin, in the form of pellets, powder, or flakes, is fed from the feeder to an inlet of the extruder where the resin is melted or compounded. In some embodiments, the dispersing agent is added to the resin through and along with the resin and in other embodiments, the dispersing agent is provided separately to the twin screw extruder. The resin melt is then delivered from the mix and convey zone to an emulsification zone of the extruder where the initial amount of water and base from the water and base reservoirs are added through an inlet. In some embodiments, dispersing agent may be added additionally or exclusively to the water stream. In some embodiments, the emulsified mixture is further diluted with additional water inlet from water reservoir in a dilution and cooling zone of the extruder. Typically, the dispersion is diluted to at least 30 weight percent water in the cooling zone. In addition, the diluted mixture may be diluted any number of times until the desired dilution level is achieved. In some embodiments, water is not added into the twin screw extruder but rather to a stream containing the resin melt after the melt has exited from the extruder. In this manner, steam pressure build-up in the extruder is eliminated.

### Forming a Multilayer Laminated Structure

In one embodiment, the method for making a multilayer laminated structure according to the present invention comprises the steps of (1) providing one or more skin layers comprising a polymeric material; (2) providing one or more one or more base layers; (3) providing one or more polyolefin dispersions comprising (a) at least one or more base polymers; (b) at least one or more stabilizing agents; (c) a liquid media; and (d) optionally one or more neutralizing agents; (4) applying the one or more polyolefin dispersions to one or more surfaces of the one or more base layers; (5) removing at least a portion of the liquid media from the one or more polyolefin dispersions; (6) thereby forming one or more adhesive layers, wherein at least one adhesive layer is associated with at least one surface of said base layer; (7) thereby forming a first intermediate structure; (8) heat laminating the one or more skin layers to the intermediate structure; thereby forming the multilayer structure, wherein the adhesive layer is disposed therebetween the skin layer and the base layer.

In lamination process, one or more base layers are provided. One or more polyolefin dispersions are applied to at least one or more surfaces of the one or more base layers. The application of one or more polyolefin dispersions may be achieved via any method, for example, via any conventional method including, but not limited to, spraying, dipping, roll coating, blade coating, curtain coating, printing techniques such as flexography and rotogravure, size press, metered size press, screen coating, rod coating combinations thereof, and the like. The dispersion composition may be applied to the base layer in any amount. For example, the dispersion composition may be applied to base layer in an amount to produce one or more adhesive layers, wherein each adhesive layer has a coat weight, based on the dry weight of the dispersion, in the range of 1 g per m² of the base layer to 2000 g per m² of the base layer, or in the range of 1 g per m² of the base layers to 500 g per m² of the base layers, or in the range of 1 g per m² of the base layers to 250 g per m² of the base layers, in the range of 1 g per m² of the base layers to 100 g per m² of the base layers. After one or more base layers are coated with the dispersion composition, at least a portion of the liquid media is removed.

The dispersion applied onto one or more base layers may be dried via any conventional drying method. Such conventional drying methods include but, are not limited to, air drying, convection oven drying, hot air drying, microwave oven drying, and/or infrared oven drying. The dispersion applied onto one or more base layers may be dried at any temperature; for example, it may be dried at a temperature in the range of equal or greater than the melting point temperature of the base polymer; or in the alternative, it may be dried at a temperature in the range of less than the melting point of the base polymer. The dispersion applied onto one or more base layers may be dried at a temperature in the range of about 60° F. (15.5° C.) to about 700° F. (371° C.); for example 60° F. (15.5° C.) to 500° F. (260° C.), or in the alternative, from 60° F. (15.5° C.) to 450° F. (232.2° C.). The temperature of the dispersion applied onto one or more base layers may be raised to a temperature in the range of equal or greater than the melting point temperature of the base polymer for a period of less than about 40 minutes; for example a period of less than about 20 minutes, or in the alternative, a period of less than about 10 minutes, or in another alternative, a period in the range of about 0.1 to 600 seconds. In another alternative, the temperature of the dispersion applied onto one or more base layers may be raised to a temperature in the range of less than the melting point temperature of the base polymer for a period of less than 40 minutes; for example, a period of less than about 20 minutes, or in the alternative, a period of less than about 10 minutes, or in another alternative, a period in the range of about 0.1 to 600 seconds.

Drying the dispersion applied onto a one or more base layers at a temperature in the range of equal or greater than the melting point temperature of the base polymer facilitates the formation of a film having a continuous base polymer phase with a discrete stabilizing agent phase dispersed therein the continuous base polymer phase thereby further improving adhesion properties between the different layers.

One or more adhesive layers are formed on at least one or more surfaces of one or more base layers. The one or more adhesive layers associated with one or more surfaces of one or more base layers, and one or more skin layers are laminated together via application of heat and pressure for an appropriate of time; thereby forming the multilayer structure of the present invention. Such lamination techniques are generally known to those skilled in the art, and any conventional method may be use.

In one embodiment, one or more dispersions are applied to one or more surfaces of one or more skin layers to form one or more adhesive layers. The one or more adhesive layers associate with one or more surfaces of one or more skin layers, and one or more base layers may subsequently be laminated together via application of heat and a pressure for an appropriate amount of time.

In another alternative, one or more dispersions are applied both to one or more surfaces of one or more bases layers and one or more skin layers, and then, be laminated via application of heat and pressure for an appropriate amount of time.

### End-Use Applications

The multilayer laminated structures according to the present invention may be formed into articles such as furniture, e.g. computer desks, coffee tables, automotive interior articles, ready to make furniture, school furniture, kitchen cabinets, wet area cabinetry, partition panel/walls, and countertops.

### EXAMPLES

The following examples illustrate the present invention but are not intended to limit the scope of the invention. The examples of the instant invention demonstrate that multilayer structures according to instant invention possess acceptable adhesion properties between PVC and MDF, good leveling properties, and more stable viscosity with lower activation temperatures while eliminating the need for a solvent or crosslinking at high temperatures.

### Formulation Components:

Dispersion A is an olefin block copolymer based dispersion having an average particle size diameter in the range of 1 μm. Dispersion A comprises 41.65 percent by weight of an olefin block copolymer, i.e. an ethylene octene copolymer with an ethylene to octene ratio of approximately 1.7, a density of approximately 0.877 g/cm³ according to ASTM D-792, and a melt index of approximately 5 g/10 minutes according to ASTM D-1238 @ 190° C. and 2.16 kg. Dispersion A further comprises 7.35 percent by weight of an stabilizing agent comprising an ethylene acrylic acid copolymer having a density of approximately 0.958 g/cm³ according to ASTM D-792, and a melt index of approximately 300 g/10 minutes according to ASTM D-1238, and a melt flow rate of approximately 13.8 according to ASTM D-1238, which is available from The Dow Chemical Company under the tradename PRIMACOR™. Dispersion A further comprises 49.98 percent by weight of water, 0.97 percent by weight of KOH, 0.05 percent by weight Conguard BIT 20 AS biocide (CAS Reg. NO. 2634-33-5), which is commercially available from Dow Chemical Company. Dispersion A is diluted to form Component A, i.e. a polyolefin dispersion having an adjusted solid content of 40 weight percent, a pH of 9.5, a viscosity of approximately 300 cps, and average particle size diameter in the range of 1 μm.

Dispercoll U54 (Component A1) is an aqueous polyurethane dispersion, which is commercially available from Bayer Corporation, having an adjusted solid content of approximately 40 weight percent.

BYK-349 (Component B) is a surfactant, which is commercially available from BYK Corporation.

DSX-3291 (Component C) is an associative thickener, which is commercially available from Cognis Corporation.

The formulations were prepared by mechanical stirring of listed components of Table 1 at approximately 25° C. for about 15 minutes.

### Other Structural Components

PVC sheet (Component E) is a skin layer, having a thickness of approximately 0.16 mm, having a surface sanded, which was provided by Shanghai Shipike Company.

MDF (Component F) is a medium density fiberboard, as a base layer, having a thickness of approximately 5 mm, the surface of which was cleaned with acetone just immediately prior to use, which was provided by Shanghai Yaershi MDF Company.

### Forming Multilayer Laminated Structures

In general, Component F, MDF, as the substrate layer is coated with different formulations as shown in Table 1, and then air-dried. Subsequently, a skin layer is thermally laminated to the coated base layer. The laminated structure may further be vacuum molded to form desired shapes.

The adhesive formulations listed in Table 1 were coated onto one surface of a PVC sheet (Component E) and an MDF (Component F) via a wire rod to form a film of approximately 75 The coated PVC sheet and MDF were maintained in a horizontal position at approximately 25° C. overnight to dry. The dry coated PCV sheet and MDF were cut into strips of 2.5 cm×25 cm. The coated surface of one PVC strip and one coated MDF strip were pressed together for one minute under a load of 0.4 metric ton. The operating temperature for Component A was 130° C. and for A1 was 90° C.

The samples were cooled at room temperature for more than one hour, and 180° peel strengths were tested on a tensile tester (Instron 5565, available from Instron Corporation) using a cross-head speed of 152.4 mm/min, according to ASTM D-903. The peel strengths were recorded in N/mm. The results are shown in Table 2, and FIGS. 2A-B. Referring to FIGS. 2A-B, the results show that the laminated multilayer structure based on a polyolefin dispersion possesses comparable peel strengths relative to those laminated structures based on current polyurethane dispersions, i.e. fiber tear in either case; however, the inventive laminated multilayer structures possesses improved VOC properties, as shown below. The results indicated that the failure is occurring in the MDF base layer rather than via adhesive failure.

Test Methods

Test methods include the following:

180° peel strength was determined on a tensile tester (Instron 5565, available from Instron Corporation) using a cross-head speed of 152.4 mm/min, according to ASTM D-903.

Volatile organic carbons (VOC) was determined according to the following method. An adsorption tube (provided by Gerstel), packed with 100 mg Carbotrap B (Supelco #2-0287) and 200 mg Carbotrap C (Supelco #2-0309), was pretreated by baking at 325° C. for 30 minutes under 70 mL/min N₂ and cooling under N₂ flow to room temperature. The sampling chamber was conditioned in an oven at 45° C. The pretreated adsorption tube was attached to the chamber. A sample, which was placed on an aluminum foil, was put into the chamber and flushed with N₂ flow for 1.5 hours to get all the organic volatiles to be adsorbed to the packing in the adsorption tube. The adsorption tube was then transferred for TDS/GC/MS analysis.

2 μL of the standard solution of hexadecane in methanol at 0.2 μg/μL was used as the external standard for calibration of GC. The concentration of total VOC of the sample was calculated as:

Total VOC (μg/g)=0.4×(total peaks area of sample)/((peak area of hexadecane)*(sample weight in g))

The parameters for TDS/GC/MS are:

Gerstel:
TDS-2: Sample Mode: Sample Remove
   Flow Mode: Splitless
   Initial Temp: 20° C.
   Initial time: 1 minute
   Delay Time: 1 minute
   1st Rate: 60° C./min
   1st Final Temp: 300° C.
   1st Final time: 10 minutes
CIS-4: Initial Temp: −50° C.
   Initial Time: 0.01 minutes
   Equilibrium Time: 0 minutes
   1st Rate: 12° C./min
   1st Final Temp: 300° C.
   1st Final Time: 10 minutes
Transfer line: Temp: 320° C.

Gas Chromatograph/Mass Spectrometer (GC/MS):
MS: Sample mass: 33 to 550
GC Oven: Initial temperature: 40° C. for 2 minutes
   Rate: 12° C./Min
   Final temperature: 280° C. for 20 minutes
   Total run time: 42 minutes
Volatile Inlet: Mode: Split
   Initial Temp: 240° C. (On)
   Pressure: 16.25 psi
   Split Ratio 15:1
   Split Flow: 60.0 mL/min
   Total flow: 66.4 mL/min
   Gas Type Helium
Column: Agilent HP-5Ms, 0.25 mm ID×0.25 um, 30 m
   Mode: Constant Flow
   Initial Flow: 2.0 mL/min
   Nominal init pressure: 16.27 psi
Inlet: Back Inlet (or where VI is located)
Outlet: MSD
   Outlet pressure: Vacuum
Integrator: Chemstation integrator

The present invention may be embodied in other forms without departing from the spirit and the essential attributes thereof, and, accordingly, reference should be made to the appended claims, rather than to the foregoing specification, as indicating the scope of the invention.

TABLE 1

| | Example 1 | Comparative Example |
|---|---|---|
| Materials | (grams) | (grams) |
| Component A | 99.50 | — |
| Component A1 | — | 99.50 |
| BYK-349 | 0.25 | 0.25 |
| DSX-3291 | 0.25 | 0.25 |

TABLE 2

| | 180° Peel strength |
|---|---|
| Inventive Example 1 | 1.1 N/mm |
| Comparative Example 1 | 2.4 N/mm |

TABLE 3

| | Total VOC |
|---|---|
| Inventive Example 1 | 22.4 μg/g |
| Comparative Example 1 | 41.4 μg/g |

1. A laminated multilayer structure comprising:
one or more skin layers comprising a polymeric material;
one or more adhesive layers derived from one or more polyolefin dispersions;
one or more base layers comprising a wood based material;
wherein said adhesive layer is disposed therebetween said base layer and said skin layer.

2. A process for making a multilayer laminated structure comprising the steps of:
providing one or more skin layers comprising a polymeric material;
providing one or more one or more base layers comprising a wood based material;
providing one or more polyolefin dispersions comprising;
at least one or more base polymers;
at least one or more stabilizing agents;
a liquid media; and
optionally one or more neutralizing agents;
applying said one or more polyolefin dispersions to one or more surfaces of said one or more base layers;
removing at least a portion of the liquid media from said one or more polyolefin dispersions;
thereby forming one or more adhesive layers, wherein at least one adhesive layer is associated with at least one surface of said base layer;
thereby forming a first intermediate structure;
heat laminating said one or more skin layers to said intermediate structure;
thereby forming said multilayer structure, wherein said adhesive layer is disposed therebetween said skin layer and said base layer.

3. The process according to claim 2, wherein said process further comprises the steps of:
applying said one or more polyolefin dispersions to one or more surfaces of said one or more skin layers;
removing at least a portion of the liquid media from said one or more polyolefin dispersions;
thereby forming one or more adhesive layers, wherein at least one adhesive layer is associated with at least one surface of said one or more skin layers.

4. The process of claim 2, wherein said heat lamination step further comprises the use of vacuum or pressure.

5. An article comprising the multilayer structure of claim 1.

6. The article of claim 5, wherein said article is a kitchen countertop, kitchen cabinet, furniture, door, interior wall panel, or partition wall panel.

7. The structure of claim 1, wherein each one or more of said adhesive layers has a thickness in the range of from 10 to 500 μm.

8. The structure of claim 1, wherein each one or more of said skin layers has a thickness in the range of from 10 to 5000 μm.

9. The structure of claim 1, wherein said each one or more of said base layers has a thickness in the range of from 0.5 to 20 mm.

10. The process according to claim 2, wherein each one or more of said adhesive layers has a thickness in the range of from 10 to 500 μm.

11. The process according to claim 2, wherein each one or more of said skin layers has a thickness in the range of from 10 to 5000 μm.

12. The process according to claim 2, wherein said each one or more of said base layers has a thickness in the range of from 0.5 to 20 mm.
